(19) United States
(12) Patent Application Publication
(10) Pub. No.: US 2025/0309485 A1
(43) Pub. Date: Oct. 2, 2025

(54) BATTERY MODULE

(71) Applicant: HONDA MOTOR CO., LTD., Tokyo (JP)

(72) Inventors: Keishi Kosaka, Wako-shi (JP); Gentaro Fujii, Wako-shi (JP)

(21) Appl. No.: 19/063,405

(22) Filed: Feb. 26, 2025

(30) Foreign Application Priority Data
Mar. 28, 2024 (JP) 2024-053962

(51) Int. Cl. H01M 50/503; H01M 10/0525; H01M 50/204; H01M 50/289; H01M 50/507

(52) U.S. Cl. CPC H01M 50/503; H01M 50/289; H01M 50/507; H01M 10/0525; H01M 50/204

(57) ABSTRACT

A battery module includes: a plurality of battery cells laminated in one direction; a constraint body constraining the plurality of battery cells in a lamination direction; a busbar connecting the battery cells to each other; and a busbar holder holding the busbar, wherein the busbar holder has a first extensible portion following displacement of the battery cells in the lamination direction.

### CROSS-REFERENCE TO RELATED APPLICATION

Priority is claimed on Japanese Patent Application No. 2024-053962, filed on Mar. 28, 2024, the contents of which are incorporated herein by reference.

### BACKGROUND

### Field of the Invention

The present invention relates to a battery module.

### Background

In the related art, it is known that when a battery module is formed by laminating battery cells which expand and contract (for example, batteries using a lithium metal in an anode), elastic members or springs for absorbing expansion and contraction of the battery cells are disposed between battery cells adjacent to each other in order to fix tab leads of the battery cells. In addition, it is known that an extensible busbar is used for connecting battery cells adjacent to each other (for example, refer to Japanese Unexamined Patent Application, First Publication No. 2015-207442).

### SUMMARY

However, if elastic members or springs are disposed between battery cells adjacent to each other, the elastic members or the springs occupy space inside a battery module, causing a decline in energy density of the entire battery module and increase in mass of the battery module. In addition, even if elastic members or springs are disposed between battery cells adjacent to each other, the amount of expansion and the amount of contraction vary depending on the battery cell, and this variation causes stress in tab leads of the battery cells, which may lead to deterioration and short circuits due to bending of current collection portions of the battery cells. Moreover, expansion and contraction of busbars alone cannot curb bending of the current collection portions of the battery cells because busbar holders constituting gaps between the busbars are fixed.

An object of an aspect of the present invention is to provide a battery module having a high energy density, curbing bending of current collection portions of battery cells, and being able to curb deterioration and short circuits due to bending of the current collection portions of the battery cells. The aspect of the present invention will contribute to stable battery performance, improvement in quality control over manufacturing steps, and energy efficiency.

A first aspect of the present invention is a battery module including: a plurality of battery cells laminated in one direction; a constraint body constraining the plurality of battery cells in a lamination direction; a busbar connecting the battery cells to each other; and a busbar holder holding the busbar, wherein the busbar holder has a first extensible portion following displacement of the battery cells in the lamination direction.

In the battery module according to the first aspect of the present invention, the busbar holder has the first extensible portion following displacement of the plurality of battery cells in the lamination direction, and there is no member occupying space inside the battery module. Therefore, the energy density of the entire battery module does not decline, and an increase in mass of the battery module can be curbed. In addition, the first extensible portion of the busbar holder extends and contracts such that it follows displacement of the plurality of battery cells in the lamination direction in response to expansion and contraction of the battery cells. Therefore, the first extensible portion can absorb expansion and contraction of the battery cells, and deterioration and short circuits due to bending of current collection portions of the battery cells can be curbed.

A second aspect is the battery module according to the first aspect described above, wherein an elastic member may be disposed between the constraint body and a battery cell among the plurality of battery cells or between the battery cells.

In the battery module according to the second aspect of the present invention, the elastic member is disposed between the constraint body and the battery cell or between the battery cells. Therefore, the elastic member can absorb expansion and contraction of the battery cells, and deterioration and short circuits due to bending of the current collection portions of the battery cells can be curbed.

A third aspect is the battery module according to the first or second aspect described above, wherein the busbar may have a second extensible portion following displacement of the battery cells in the lamination direction.

In the battery module according to the third aspect of the present invention, the second extensible portion of the busbar extends and contracts such that it follows displacement of the plurality of battery cells in the lamination direction in response to expansion and contraction of the battery cells. Therefore, the second extensible portion can absorb expansion and contraction of the battery cells, and deterioration and short circuits due to bending of the current collection portions of the battery cells can be curbed.

A fourth aspect is the battery module according to any one of the first to third aspects described above, wherein the busbar holder may have a rail allowing the busbar to move in the lamination direction of the battery cells.

In the battery module according to the fourth aspect of the present invention, the busbar holder has the rail allowing the busbar to move in the lamination direction of the battery cells. Therefore, the busbar can move along the rail in response to expansion and contraction of the battery cells, and deterioration and short circuits due to bending of the current collection portions of the battery cells can be curbed.

A fifth aspect is the battery module according to any one of the first to fourth aspects described above, wherein an anode constituting the battery cells may include a material containing lithium metal or silicon.

In the battery module according to the fifth aspect of the present invention, even if the anode constituting the battery cells includes a material containing lithium metal or silicon, the first extensible portion of the busbar holder extends and contracts such that it follows displacement of the plurality of battery cells in the lamination direction in response to expansion and contraction of the battery cells. Therefore, the first extensible portion can absorb expansion and contraction of the battery cells, and deterioration and short circuits due to bending of the current collection portions of the battery cells can be curbed.

A sixth aspect is the battery module according to any one of the first to fifth aspects described above, wherein the battery cells may be a solid-state battery.

In the battery module according to the sixth aspect of the present invention, even if the battery cells are a solid-state battery, there is no member occupying space inside the battery module. Therefore, the weight can be reduced.

According to the aspect of the present invention, it is possible to provide a battery module having a high energy density, curbing bending of current collection portions of battery cells, and being able to curb deterioration and short circuits due to bending of the current collection portions of the battery cells.

### BRIEF DESCRIPTION OF THE DRAWINGS

FIG. 1 is a schematic view showing the constitution of a battery module according to a first embodiment of the present invention.

FIG. 2 is a schematic view showing the constitution of the battery module according to the first embodiment of the present invention.

FIG. 3 is a schematic view showing the constitution of a battery module according to a second embodiment of the present invention.

FIG. 4 is a schematic view showing the constitution of the battery module according to the second embodiment of the present invention.

FIG. 5 is a schematic view showing the constitution of a battery module according to a third embodiment of the present invention.

FIG. 6 is a schematic view showing the constitution of the battery module according to the third embodiment of the present invention.

FIG. 7 is a schematic view showing the constitution of a battery module according to a fourth embodiment of the present invention.

### DESCRIPTION OF EMBODIMENTS

Hereinafter, a battery module according to an embodiment of the present invention will be described with reference to the drawings.

### [Battery Module]

### First Embodiment

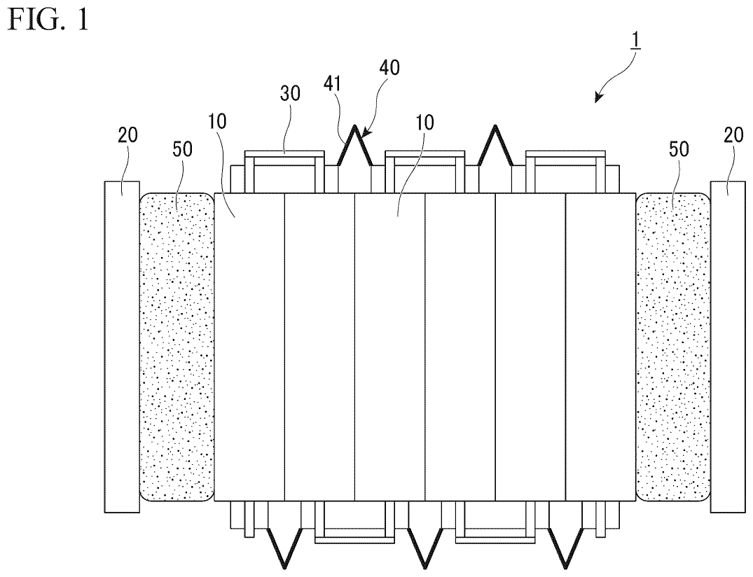

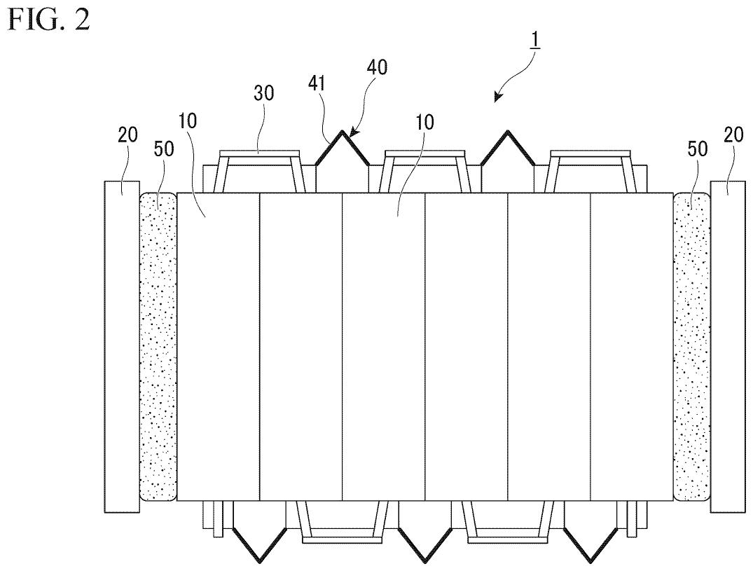

FIGS. 1 and 2 are schematic views showing constitutions of a battery module according to a first embodiment of the present invention. In the drawings used in the following description, in order to make characteristics easy to understand, characteristic portions may be shown in an enlarged manner for the sake of convenience, and dimensional ratios or the like of each constituent element are not limited to exemplary examples.

As shown in FIGS. 1 and 2, a battery module 1 of the present embodiment includes a plurality of battery cells 10, constraint bodies 20, busbars 30, and busbar holders 40.

The plurality of battery cells 10 are laminated in one direction (a transverse direction in FIG. 1). The constraint bodies 20 constrain the plurality of battery cells 10 from both sides in a lamination direction (both sides in the transverse direction in FIG. 1).

The busbars 30 connect adjacent battery cells 10 in the lamination direction of the plurality of battery cells 10. The busbar holders 40 are provided such that they extend in the lamination direction of the plurality of battery cells 10 and hold the busbars 30 from both sides in a longitudinal direction of the busbars 30 (a direction orthogonal to the lamination direction of the plurality of battery cells 10).

The busbar holders 40 each have a first extensible portion 41 following displacement of the battery cells 10 in the lamination direction.

In the battery module 1 according to the present embodiment, an elastic member 50 can be preferably disposed between the constraint body 20 and the battery cell 10. Accordingly, the elastic member 50 can absorb expansion and contraction of the battery cells 10, and deterioration and short circuits due to bending of current collection portions of the battery cells 10 can be curbed.

### (Battery Cell)

The battery cell in the present embodiment has a cathode, an anode, an electrolyte layer, and an exterior film. The battery cell is not particularly limited, but it is preferably a solid-state battery. Also, if the battery cell 10 is a solid-state battery, there is no member occupying space inside the battery module 1. Therefore, the weight can be reduced.

### (Cathode)

The cathode is constituted by laminating a first current collector layer and first active material layers including at least a cathode active material. In the present embodiment, the cathode has the first current collector layer and the first active material layers formed on both main surfaces of the first current collector layer.

The first current collector layer can be preferably constituted of at least one material having a high conductivity.

Examples of highly conductive materials include metals or alloys containing at least one of metal elements such as silver (Ag), palladium (Pd), gold (Au), platinum (Pt), aluminum (Al), chromium (Cr), and nickel (Ni), and non-metals such as carbon (C). In consideration of the manufacturing cost as well as the high conductivity, aluminum, nickel, or stainless steel can be preferably used. Moreover, aluminum is unlikely to react with the cathode active material and the electrolyte. For this reason, if aluminum is used for the first current collector layer, the internal resistance of the battery can be reduced.

Examples of forms of the first current collector layer can include a foil form, a plate form, a mesh form, a non-woven fabric form, and a foam form. In addition, in order to enhance adhesion to the first active material layers, carbon or the like may be disposed on a surface of the first current collector layer, or the surface may be coarsened.

The first active material layers include the cathode active material exchanging lithium ions and electrons. The cathode active material is not particularly limited as long as it is a material capable of reversibly releasing and absorbing lithium ions and transferring electrons, and a known cathode active material which can be applied to a cathode of a lithium-ion battery can be used. Examples of the cathode active material include composite oxides such as lithium cobalt oxide (LiCoO₂), lithium nickel oxide (LiNiO₂), lithium manganese oxide (LiMn₂O₄), solid solution oxides such as (Li₂MnO₃—LiMO₂ (M=Co, Ni, or the like)), lithium-manganese-nickel-cobalt oxide (LiNiₓMn_{y}Co_{z}O₂, x+y+z=1), and olivine-type lithium phosphate oxide (LiFePO₄); conductive polymers such as polyaniline and polypyrrole; sulfides such as Li₂S, CuS, Li—Cu—S compounds, TiS₂, FeS, MoS₂, and Li—Mo—S compounds; and mixtures of sulfur and carbon. The cathode active material may be constituted of one kind of the foregoing materials alone or may be constituted of two or more kinds thereof.

The first active material layers include an electrolyte exchanging lithium ions with the cathode active material. The electrolyte is not particularly limited as long as it has lithium-ion conductivity, and a material generally used for a lithium-ion battery can be used. Examples of the electrolyte can include inorganic solid electrolytes such as sulfide solid electrolyte materials, oxide solid electrolyte materials, halide solid electrolytes, and lithium-containing salts, polymer-based solid electrolytes such as polyethylene oxide, and gel-based solid electrolytes containing lithium-containing salts or lithium-ion conductive ionic liquids. Among these, sulfide solid electrolyte materials are preferable from the viewpoint of high conductivity properties of lithium ions, favorable structural formability by pressing, and favorable interfacial bonding properties.

The electrolyte may be constituted of one kind of the foregoing materials alone or may be constituted of two or more kinds thereof.

The electrolyte included in the first active material layers may be the same material as or may be a material different from the electrolyte included in second active material layers and the solid electrolyte layer.

From the viewpoint of improvement in conductivity of the cathode, the first active material layers may also contain a conductive additive. A conductive additive which can be generally used for lithium-ion batteries can be used as the conductive additive.

Examples of the conductive additive can include carbon black such as acetylene black or Ketjen black; carbon fibers; vapor grown carbon fibers; graphite powder; and carbon materials such as carbon nanotubes. The conductive additive may be constituted of one kind of the foregoing materials alone or may be constituted of two or more kinds thereof.

In addition, the first active material layers may also contain a binder playing a role in binding the cathode active materials to each other, and the cathode active material and the first current collector layer to each other.

The first active material layers may be formed on both the main surfaces of the first current collector layer or may be formed on only one main surface of the first current collector layer. In addition, when the cathode is a single-sided coated electrode, a laminated cathode in which two cathodes are laminated such that their current collector surfaces face each other may be used as a double-sided coated electrode. In addition, when the first current collector layer has a three-dimensional porous structure, such as a mesh form, a non-woven fabric form, or a foam form, the first current collector layer may be provided integrally with the first active material layers.

The first current collector layer is assembled at one end portion in a width direction of an all-solid-state battery.

The first active material layers come into contact with the electrolyte layer. Therefore, they may contain sulfides contained in the electrolyte layer.

### (Anode)

The anode is constituted by laminating a second current collector layer and the second active material layers including at least an anode active material. In the present embodiment, the anode has the second current collector layer and the second active material layers formed on both main surfaces of the second current collector layer and including the anode active material and the electrolyte.

The second current collector layer contains at least copper (Cu). Similar to the first current collector layer, the second current collector layer may contain materials other than copper having a high conductivity. Examples of the materials other than copper having a high conductivity include metals or alloys containing at least one of metal elements such as silver (Ag), palladium (Pd), gold (Au), platinum (Pt), chromium (Cr), and nickel (Ni), and non-metals such as carbon (C). In consideration of the manufacturing cost as well as the high conductivity, nickel or stainless steel can be preferably used as the materials other than copper. Moreover, stainless steel is unlikely to react with the cathode active material, the anode active material, and the electrolyte. For this reason, if stainless steel is used for the second current collector layer, the manufacturing cost of the battery can be reduced.

Examples of forms of the second current collector layer can include a foil form, a plate form, a mesh form, a non-woven fabric form, and a foam form. In addition, in order to enhance adhesion to the second active material layers, carbon or the like may be disposed on a surface of the second current collector layer, or the surface may be coarsened.

The second active material layers include the anode active material exchanging lithium ions and electrons. The anode active material is not particularly limited as long as it is a material capable of reversibly releasing and absorbing lithium ions and transferring electrons, and a known anode active material which can be applied to an anode of a lithium-ion battery can be used. Examples of the anode active material include carbonaceous materials such as natural graphite, artificial graphite, resin charcoal, carbon fibers, activated charcoal, hard carbon, and soft carbon; alloy-based materials mainly consisting of tin, a tin alloy, silicon, a silicon alloy, gallium, a gallium alloy, indium, an indium alloy, aluminum, an aluminum alloy, and the like; conductive polymers such as polyacene, polyacetylene, and polypyrrole; metallic lithium; and lithium-titanium composite oxides (for example, Li₄Ti₅O₁₂). These anode active materials may be constituted of one kind of the foregoing materials alone or may be constituted of two or more kinds thereof.

The second active material layers include an electrolyte exchanging lithium ions with the anode active material. The electrolyte is not particularly limited as long as it has lithium-ion conductivity, and a material generally used for a lithium-ion battery can be used. Examples of the electrolyte can include inorganic solid electrolytes such as sulfide solid electrolyte materials, oxide solid electrolyte materials, halide solid electrolytes, and lithium-containing salts, polymer-based solid electrolytes such as polyethylene oxide, and gel-based solid electrolytes containing lithium-containing salts or lithium-ion conductive ionic liquids. The electrolyte may be constituted of one kind of the foregoing materials alone or may be constituted of two or more kinds thereof.

The electrolyte included in the second active material layers may be a material similar to or different from the electrolyte included in the first active material layers and the solid electrolyte layer.

The second active material layers may also contain a conductive additive, a binder, and the like. These materials are not particularly limited. However, for example, materials similar to those used for the first active material layers described above can be used.

The second active material layers may be formed on both the main surfaces of the second current collector layer or may be formed on only one main surface of the second current collector layer. In addition, when the second current collector layer has a three-dimensional porous structure, such as a mesh form, a non-woven fabric form, or a foam form, the second current collector layer may be provided integrally with the second active material layers.

The anode may include a material containing lithium metal or silicon. As shown in FIGS. 1 and 2, the first extensible portion 41 of the busbar holder 40 extends and contracts such that it follows displacement of the plurality of battery cells 10 in the lamination direction in response to expansion and contraction of the battery cells 10. Therefore, the first extensible portion 41 can absorb expansion and contraction of the battery cells 10, and deterioration and short circuits due to bending of the current collection portions of the battery cells 10 can be curbed.

### (Electrolyte Layer)

The electrolyte layer is disposed between the first active material layer and the second active material layer.

The electrolyte is not particularly limited as long as it has lithium-ion conductivity and insulation properties, and a material generally used for a lithium-ion battery can be used. Examples thereof can include inorganic solid electrolytes such as sulfide solid electrolyte materials, oxide solid electrolyte materials, halide solid electrolytes, and lithium-containing salts, polymer-based solid electrolytes such as polyethylene oxide, and gel-based electrolytes containing lithium-containing salts or lithium-ion conductive ionic liquids. Among these, sulfide solid electrolyte materials are preferable from the viewpoint of high conductivity properties of lithium ions, favorable structural formability by pressing, and favorable interfacial bonding properties.

The form of the electrolyte materials is not particularly limited. However, examples thereof can include a form of particles.

The electrolyte layer may contain an adhesive for imparting mechanical strength and flexibility.

The electrolyte layer may have a sheet shape having a porous substrate and a solid electrolyte held in the porous substrate. The form of the foregoing porous substrate is not particularly limited. However, examples thereof include woven fabric, non-woven fabric, mesh cloth, a porous film, an expanded sheet, and a punching sheet. Among these forms, non-woven fabric is preferable from the viewpoint of handleability, allowing a greater filling amount of solid electrolyte.

The foregoing porous substrate can be preferably constituted of an insulating material. Accordingly, insulation properties of the electrolyte layer can be improved. Examples of the insulating material include resin materials such as nylon, polyester, polyethylene, polypropylene, polytetrafluoroethylene, an ethylene-tetrafluoroethylene copolymer, polyvinylidene fluoride, polyvinylidene chloride, polyvinyl chloride, polyurethane, vinylon, polybenzimidazole, polyimide, polyphenylene sulfite, polyether ether ketone, cellulose, and an acrylic resin; natural fibers such as hemp, wood pulp, and cotton lint; and glass.

### (Exterior Film)

The exterior film accommodates an electrode laminate including the cathode, the anode, and the electrolyte layer. For example, the exterior film has a sealant resin layer, a metal layer, and an outer resin layer.

According to the battery module 1 of the present embodiment, since the busbar holder 40 has the first extensible portion 41 following displacement of the battery cells 10 in the lamination direction, there is no member occupying space inside the battery module 1. Therefore, the energy density of the battery module 1 in its entirety does not decline, and increase in mass of the battery module 1 can be curbed. In addition, as shown in FIGS. 1 and 2, the first extensible portion 41 of the busbar holder 40 extends and contracts such that it follows displacement of the plurality of battery cells 10 in the lamination direction in response to expansion and contraction of the battery cells 10. Therefore, the first extensible portion 41 can absorb expansion and contraction of the battery cells 10, and deterioration and short circuits due to bending of the current collection portions of the battery cells 10 can be curbed.

### Second Embodiment

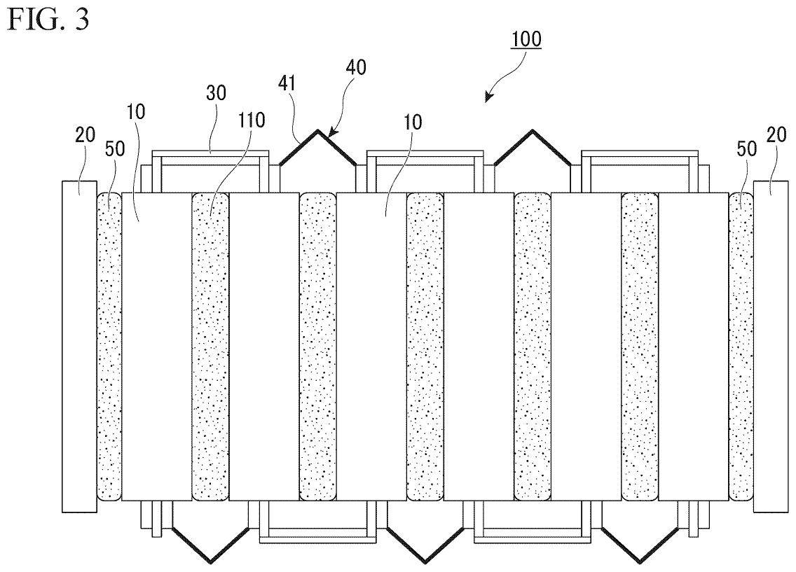

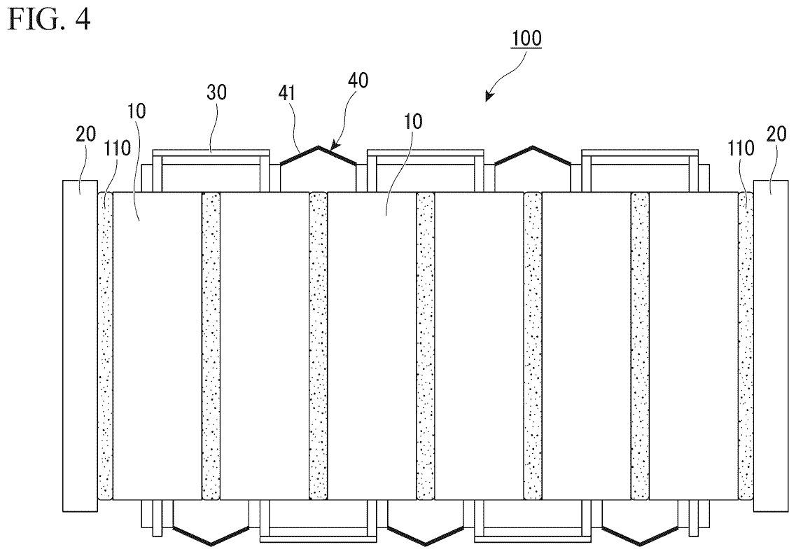

FIGS. 3 and 4 are schematic views showing constitutions of a battery module according to a second embodiment of the present invention. In FIGS. 3 and 4, the same reference signs are applied to the same constitutions as the battery module shown in FIGS. 1 and 2, and description thereof will be omitted.

As shown in FIGS. 3 and 4, a battery module 100 of the present embodiment includes a plurality of battery cells 10, constraint bodies 20, busbars 30, and busbar holders 40.

In the battery module 100 of the present embodiment, an elastic member 50 is disposed between the constraint body 20 and the battery cell 10, and an elastic member 110 is disposed between the battery cells 10. Accordingly, as shown in FIGS. 3 and 4, the elastic member 50 and the elastic member 110 can absorb expansion and contraction of the battery cells 10, and deterioration and short circuits due to bending of current collection portions of the battery cells 10 can be curbed.

### Third Embodiment

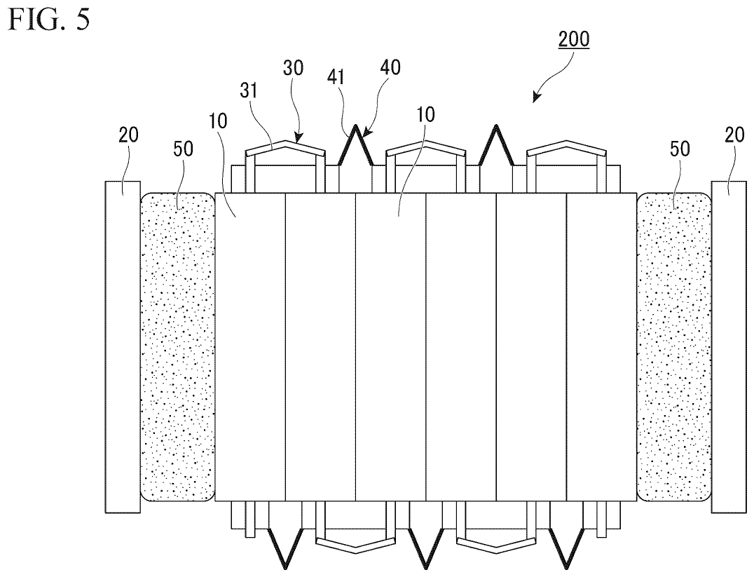

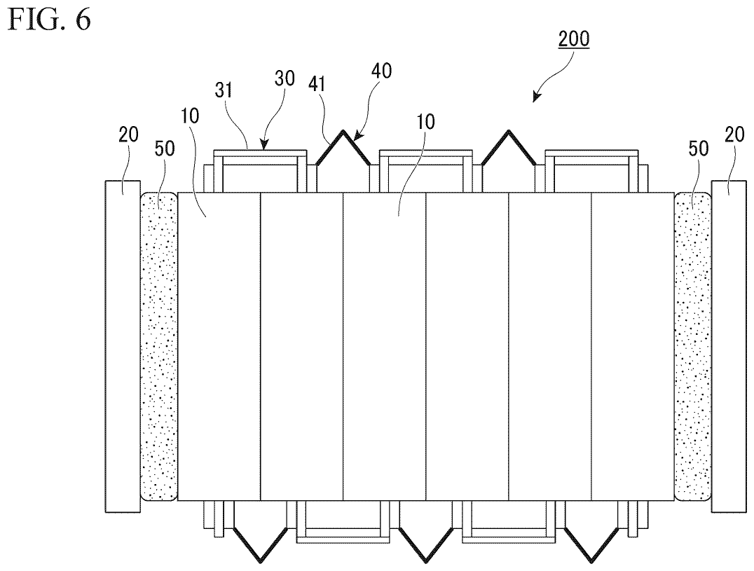

FIGS. 5 and 6 are schematic views showing constitutions of a battery module according to a third embodiment of the present invention. In FIGS. 5 and 6, the same reference signs are applied to the same constitutions as the battery module shown in FIGS. 1 and 2, and description thereof will be omitted.

As shown in FIGS. 5 and 6, a battery module 200 of the present embodiment includes a plurality of battery cells 10, constraint bodies 20, busbars 30, busbar holders 40, and elastic members 50.

In the battery module 200 according to the present embodiment, the busbar holders 40 each have a first extensible portion 41 following displacement of the battery cells 10 in the lamination direction, and the busbars 30 each have a second extensible portion 31 following displacement of the battery cells 10 in the lamination direction. Accordingly, as shown in FIGS. 5 and 6, the first extensible portion 41 of the busbar holder 40 and the second extensible portion 31 of the busbar 30 extend and contract such that they follow displacement of the plurality of battery cells 10 in the lamination direction in response to expansion and contraction of the battery cells 10. Therefore, the first extensible portion 41 and the second extensible portion 31 can absorb expansion and contraction of the battery cells 10, and deterioration and short circuits due to bending of the current collection portions of the battery cells 10 can be curbed.

### Fourth Embodiment

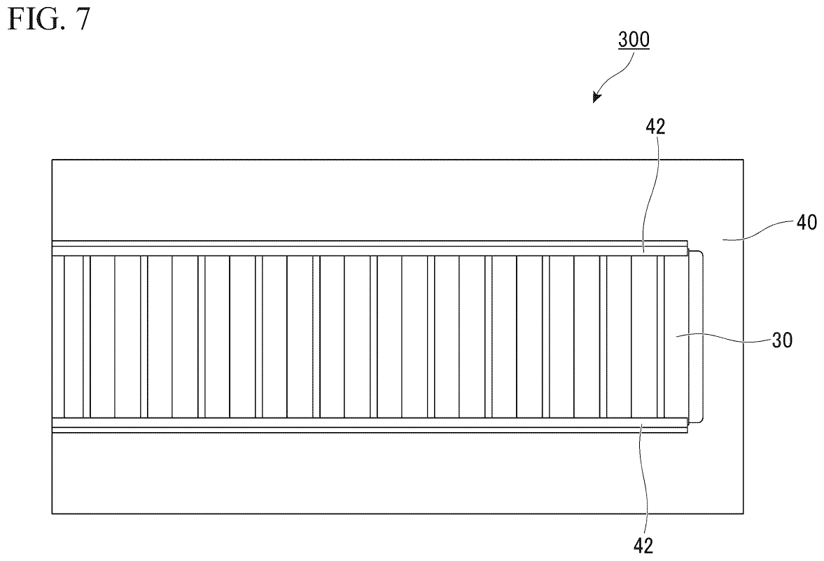

FIG. 7 is a schematic view showing the constitution of a battery module according to a fourth embodiment of the present invention. In FIG. 7, the same reference signs are applied to the same constitutions as the battery module shown in FIGS. 1 and 2, and description thereof will be omitted.

As shown in FIG. 7, a battery module 300 of the present embodiment includes a plurality of battery cells (not shown), constraint bodies (not shown), busbars 30, and busbar holders 40.

In the battery module 300 according to the present embodiment, the busbar holders 40 each have a rail 42 allowing the busbar 30 to move in the lamination direction of the battery cells 10. Accordingly, the busbar 30 can move along the rail 42 in response to expansion and contraction of the battery cells 10, and deterioration and short circuits due to bending of the current collection portions of the battery cells 10 can be curbed.

Hereinabove, embodiments of the present invention have been described in detail. However, the present invention is not limited to the foregoing embodiments, and various modifications and changes can be made within the scope of the gist of present invention described in the claims.

What is claimed is:

1. A battery module comprising:
a plurality of battery cells laminated in one direction;
a constraint body constraining the plurality of battery cells in a lamination direction;
a busbar connecting the battery cells to each other; and
a busbar holder holding the busbar,
wherein the busbar holder has a first extensible portion following displacement of the battery cells in the lamination direction.

2. The battery module according to claim 1,
wherein an elastic member is disposed between the constraint body and a battery cell among the plurality of battery cells or between the battery cells.

3. The battery module according to claim 1,
wherein the busbar has a second extensible portion following displacement of the battery cells in the lamination direction.

4. The battery module according to claim 1,
wherein the busbar holder has a rail allowing the busbar to move in the lamination direction of the battery cells.

5. The battery module according to claim 1,
wherein an anode constituting the battery cells includes a material containing lithium metal or silicon.

6. The battery module according to claim 1,
wherein the battery cells are a solid-state battery.
